(19) United States
(12) Patent Application Publication
(10) Pub. No.: US 2010/0248072 A1
(43) Pub. Date: Sep. 30, 2010

(54) FUEL CELL

(76) Inventors: Naomi Shida, Tokyo (JP); Yoshihiro Akasaka, Kawasaki-shi (JP); Yoshiyuki Isozaki, Tokyo (JP); Miki Hayashi, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/729,575

(22) Filed: Mar. 23, 2010

(30) Foreign Application Priority Data
Mar. 25, 2009 (JP) 2009-074709

(51) Int. Cl. H01M 8/10

(52) U.S. Cl. 429/483

(57) ABSTRACT

A fuel cell is provided, which includes a membrane electrode assembly including an electrolytic film sandwiched between an anode catalyst layer and a cathode catalyst layer, an anode gas diffusion layer disposed adjacent to the anode catalyst layer and a cathode gas diffusion layer disposed adjacent to the cathode catalyst layer, and a pair of separators which are in contact with the anode gas diffusion layer and the cathode gas diffusion layer, respectively. At least one of the separators includes a metallic member having a channel and an oxide layer disposed on a bottom of the channel. The oxide layer includes silica and tin oxide which accounts for 0.0001-30% by weight of silica.

### CROSS-REFERENCE TO RELATED APPLICATIONS

This application is based upon and claims the benefit of priority from prior Japanese Patent Application No. 2009-074709, filed Mar. 25, 2009, the entire contents of which are incorporated herein by reference.

### BACKGROUND OF THE INVENTION

1. Field of the Invention

This invention relates to a fuel cell.

2. Description of the Related Art

The fuel cell is designed such that the chemical energy of a fuel such as methanol is directly converted into electrical energy by electrochemically oxidizing the fuel in the cell, thereby delivering electrical energy from the cell. Since the generation of NO_{X} or SO_{X} by the combustion of fuel is prevented, fuel cells are now attracting much attention as clean sources of electrical energy.

In the case of a direct methanol fuel cell (DMFC), water is generated at the cathode by a reaction. For example, in JP-A 2006-66138 (KOKAI), there is proposed to remove the water that has been generated as described above by a separator enhanced in hydrophilicity. Specifically, even if the water vapor to be mixed with fuel gas or oxidizing gas, or the water vapor generated by the generation of electricity is condensed on the surface of the separator, the water vapor cannot be turned into water drops but can be spread as a thin water layer on the surface of the channel of fuel gas or oxidizing gas, thereby preventing the channel of these gases from being blocked.

However, according to the construction of the conventional fuel cell, the permeation of water cannot be sufficiently carried out, so that the drainage of the water that has been accumulated at the cathode would become insufficient. As a result, the supply of oxygen to the cathode is stagnated, thereby making it difficult to stably operate the fuel cell for a long time. In the case of a diffusion supply type cell which feeds air without using a pump, it is especially difficult to drain water, giving rise to the deterioration of output.

### BRIEF SUMMARY OF THE INVENTION

A fuel cell according to one aspect of the present invention comprises a membrane electrode assembly comprising an electrolytic film sandwiched between an anode catalyst layer and a cathode catalyst layer, an anode gas diffusion layer disposed adjacent to the anode catalyst layer and a cathode gas diffusion layer disposed adjacent to the cathode catalyst layer; and a pair of separators which are in contact with the anode gas diffusion layer and the cathode gas diffusion layer, respectively, at least one of the separators comprising a metallic member having a channel, and an oxide layer disposed on a bottom of the channel and comprising silica and tin oxide which accounts for 0.0001-30% by weight of silica.

### BRIEF DESCRIPTION OF THE SEVERAL VIEWS OF THE DRAWING

FIG. 1 is a cross-sectional view of the DMFC according to one embodiment;

FIG. 2 is an enlarged view illustrating the bottom construction of the channel of the separator used in one embodiment;

FIG. 3 is a cross-sectional view illustrating one step of the manufacturing method of the separator shown in FIG. 2;

FIG. 4 is a cross-sectional view illustrating a step subsequent to the step shown in FIG. 3;

FIG. 5 is a cross-sectional view illustrating one example of the step subsequent to the step shown in FIG. 4;

FIG. 6 is a cross-sectional view illustrating a step subsequent to the step shown in FIG. 5;

FIG. 7 is a cross-sectional view illustrating a step subsequent to the step shown in FIG. 6;

FIG. 8 is a cross-sectional view illustrating another example of the step subsequent to the step shown in FIG. 4;

FIG. 9 is a cross-sectional view illustrating a step subsequent to the step shown in FIG. 8;

FIG. 10 is a diagram illustrating the construction of the separator used in another embodiment;

FIG. 11 is a cross-sectional view illustrating one step of the manufacturing method of the separator shown in FIG. 10;

FIG. 12 is an enlarged diagram of the channel of a metallic member;

FIG. 13 is a cross-sectional view illustrating a step subsequent to the step shown in FIG. 11;

FIG. 14 is a cross-sectional view illustrating a step subsequent to the step shown in FIG. 13;

FIG. 15 is a cross-sectional view illustrating a step subsequent to the step shown in FIG. 14;

FIG. 16 is a graph illustrating the relationship between the quantity of covering a hydrophilic layer and the area of spreading; and

FIG. 17 is a graph showing the characteristics of a DMFC according to one embodiment.

### DETAILED DESCRIPTION OF THE INVENTION

Next, embodiments will be explained with reference to drawings. In these drawings, the same components will be identified by the same reference numbers thereby omitting the duplication of explanation. Further, these drawings are depicted schematically and hence the relationship between the thickness and the planar size as well as the ratios in thickness among the layers may differ from those actually employed. Furthermore, the relationship between the sizes as well as the ratio of components may differ from one another even among drawings.

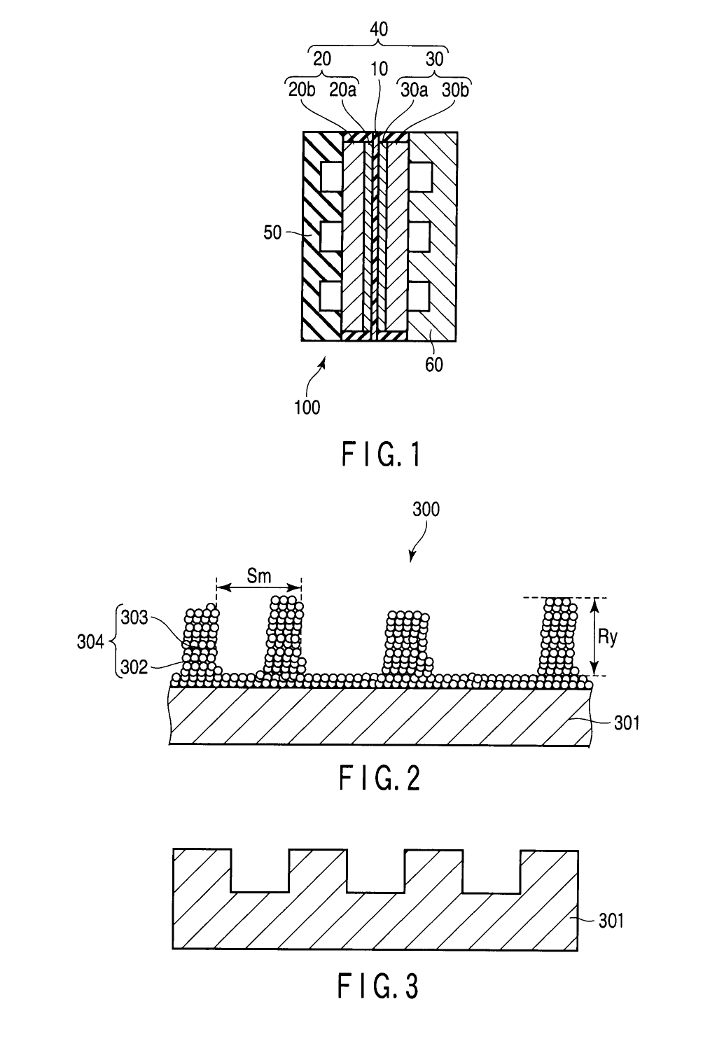

As shown in FIG. 1, in the cell 100 of the DMFC according to one embodiment, an electrolytic layer 10 is sandwiched between an anode 20 and a cathode 30, thereby constituting a membrane electrode assembly (MEA) 40. The anode 20 comprises an anode catalyst layer 20a and an anode gas diffusion layer (GDL) 20b. The cathode 30 comprises a cathode catalyst layer 30a and a cathode gas diffusion layer (GDL) 30b. In all of these electrodes, the catalyst layers 20a and 30a are contacted with the electrolytic layer 10.

Although not shown in FIG. 1, a fuel regulating layer is interposed between the anode catalyst layer 20a and the anode GDL 20b, and a cathode MPL (Micro Porous Layer) is interposed between the cathode catalyst layer 30a and the cathode GDL 30b. This cathode MPL also acts as an electrode-side densified water-repellent layer.

The catalyst layers 20a and 30a are generally constituted respectively by a porous layer comprising a catalytic active material, a conductive material and a proton conducting material. For example, these catalyst layers can be constituted by a porous layer containing a proton conducting material and a carrier catalyst having a conductive material as a carrier.

On the outside of the MEA 40, there is disposed an anode separator 50 adjacent to the anode GDL 20b. On the outside of the cathode GDL 30b, there is disposed a cathode separator 60.

On the occasion of operating the DMFC as described above, methanol and water are fed in a state of liquid (an aqueous solution of methanol) from a liquid fuel storage section (not shown) to the anode catalyst layer 20a of anode 20. Air as an oxidizing agent is fed to the cathode catalyst layer 30a. In the anode catalyst layer 20a, a catalytic reaction represented by the following reaction formula (1) takes place. In the cathode catalyst layer 30a, a catalytic reaction represented by the following reaction formula (2) takes place. In view of these reactions, the catalyst layer is also referred to as a reaction layer.

CH₃OH+H₂O→CO₂+6H⁺+6e⁻ (1)

6H⁺+(3/2)O₂+6e⁻→3H₂O (2)

In the anode catalyst layer 20a, methanol reacts with water to generate carbon dioxide, protons and electrons. Protons pass through the electrolytic film 10 to reach the cathode 30. On the other hand, in the cathode catalyst layer 30a, the electrons that have reached the cathode catalyst layer 30a after passing through an external circuit react with oxygen and protons, thereby generating water.

On this occasion, when the anode 20 and the cathode 30 are electrically connected with an external circuit, it is possible to take out electric power from the electrons thus generated. The water generated can be drained out of the cell from the cathode 30. On the other hand, the carbon dioxide generated at the anode 20 is permitted to diffuse in the fuel liquid phase and then the exhausted out of the cell through a gas-permeating membrane which permits only the permeation of gas.

The electrolytic film 10 in the DMFC according to this embodiment can be manufactured, for example, by pre-treating a perfluorocarbon sulfonate film having a predetermined dimension with hydrogen peroxide and sulfuric acid. As this perfluorocarbon sulfonate film, it is possible to employ, for example, Nafion 112 (trademark of Dupont Co. Ltd.). This perfluorocarbon sulfonate film is used by cutting it to have a predetermined size. The details of the pretreatment are described in a publication (G. Q. Lu, et al; Electrochimica Acta, 49 (2004), 821-828), for example.

The anode catalyst layer and the cathode catalyst layer are respectively formed on a PTFE sheet. The anode catalyst layer can be manufactured as follows, for example. At first, a PtRu alloy catalyst (PtRu Black Hi SPEC600, Johnson & Matthey Co., Ltd.) is mixed with and dispersed in a solution of perfluorocarbon sulfonate (Nafion solution: 5-wt % Aldrich SE-29992 Nafion; Dupont Co. Ltd.) to prepare an anode catalyst material. Then, the anode catalyst material thus obtained is coated on a PTFE sheet and dried to obtain the anode catalyst layer. The quantity coated (hereinafter referred to as the quantity of loading) of PtRu in the anode catalyst layer thus dried may be approximately 1-30 mg/cm², for example.

The cathode catalyst layer can be manufactured as follows, for example. At first, a Pt-supported carbon catalyst (HP 40% Pt on Vulcan XC-72R; E-Tek Co., Ltd.) is mixed with and dispersed in a solution of perfluorocarbon sulfonate (Nafion solution: 5-wt % Aldrich SE-20092 Nafion; Dupont Co. Ltd.) to prepare a cathode catalyst material. Then, the cathode catalyst material thus obtained is coated on a PTFE sheet and dried to obtain the cathode catalyst layer. The quantity of loading of Pt in the cathode catalyst layer thus dried may be approximately 0.5-15 mg/cm², for example.

The anode catalyst layer and the cathode catalyst layer thus obtained are respectively cut into a predetermined dimension while they are mounted on the PTFE sheet. The anode catalyst layer and the cathode catalyst layer thus cut out are contacted with the electrolytic film 10 and thermally press-adhered with the electrolytic film 10. Thereafter, the PTFE sheet is removed, thereby obtaining a laminated body comprising the anode catalyst layers 20a and the cathode catalyst layer 30a with the electrolytic film 10 being interposed therebetween. The laminated body thus obtained is referred to as a catalyst-coated membrane (CCM).

A fuel regulating layer (not shown) and an anode GDL 20b are disposed on the anode catalyst layers 20a of the CCM. As the anode GDL 20b, it is possible to employ, for example, TGPH-090, 30 wt % wetproofed (E-Tek Co., Ltd.) which is formed of a carbon paper TGPH (Toray Industries, Inc.) which is given with water repellent treatment with approximately 30 wt % PTFE. Fuel supply means for feeding a fuel to the anode GDL 20b is disposed on the anode GDL 20b. This fuel supply means comprises an anode separator 50.

A cathode MPL (not shown) and a cathode GDL 30b are disposed on the cathode catalyst layers 30a of the CCM. In this embodiment, it is possible to employ an MPL-attached cathode GDL (for example, Elat GDL LT-2500-W (approximately 360 μm thick) E-Tek Co., Ltd.). A cathode separator 60 is disposed on the cathode GDL 30b.

In the fuel cell as described above, it is required to smoothly feed an appropriate quantity of fuel to each of the electrodes in order to secure excellent characteristics of cell. Further, it is also required to enable the catalytic reaction of cell to quickly generate at the 3-phase interfaces among the catalytic active material, the proton conductive material and the fuel. Furthermore, it is also required to enable reaction products to be quickly discharged in addition to the requirement to enable electrons and protons to smoothly move.

In one embodiment, these requirements are overcome by disposing a hydrophilic layer provided, on its surface, with unevenness of predetermined dimension on the bottom of channel of the separator. More specifically, at least one separator comprises a metallic member having the channel, and a hydrophilic layer disposed on the bottom of the channel and including a base layer and an uneven layer formed on the base layer. The surface of the uneven layer has fine projections, an average interval Sm of the projections is 2×10² to 4×10² μm and the maximum height Ry of the projections is 5-15 μm.

In the separator 300 shown in FIG. 2, a hydrophilic layer 304 which is formed of a laminated body constituted by a base layer 302 and an uneven layer 303 is disposed on the bottom of the channel of the metallic member 301. An average interval Sm between the projections in the surface of the uneven layer 303 is 2×10² to 4×10² μm and the maximum height Ry of the projections is 5-15 μm.

Herein, the values of these average interval Sm and maximum height Sy are determined based on JIS B 0601-1994.

The separator shown herein can be manufactured according to the following method for instance.

First of all, as shown in FIG. 3, a metallic member 301 is prepared. As the metal, it is possible to employ any metal as long as they have a predetermined electric conductivity and heat conductivity, so that there is not any particular restriction with regard to the material of the metal. For example, it is possible to employ a stainless steel plate or a material comprising stainless steel as a base material which is surface-treated for improving corrosion resistance and conductivity. As the method of surface treatment, it may include, for example, plating treatment, the vapor deposition of a metallic film such as gold and the cladding with a gold film. Further, it is also possible to employ a carbon-aluminum composite material comprising a base material made of aluminum and covered thereon with carbon.

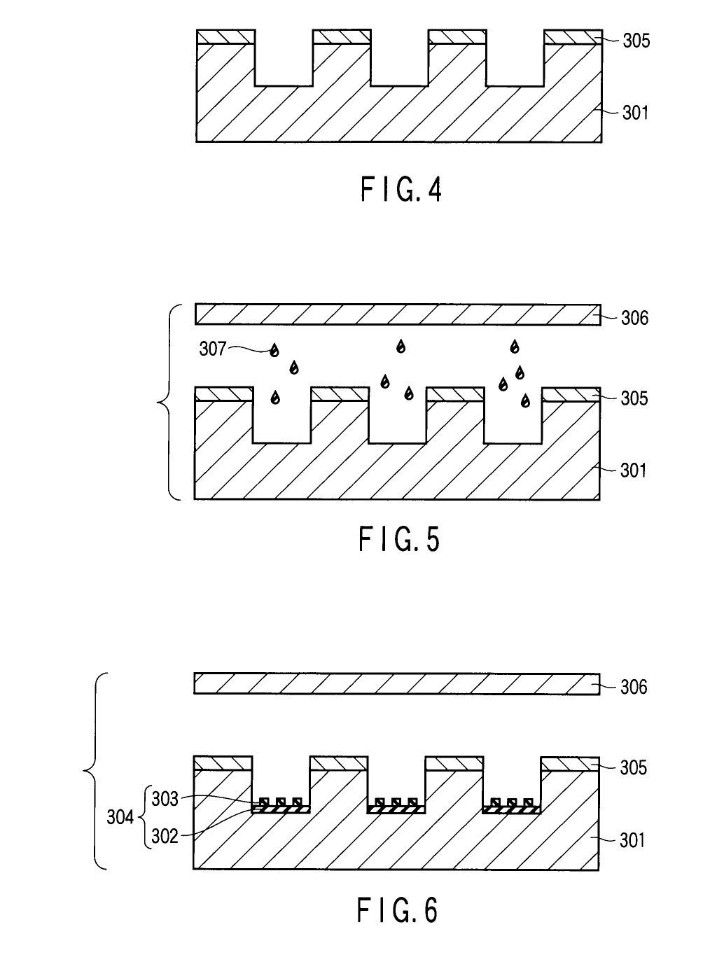

As shown in FIG. 4, the member 301 is covered with a covering layer 305 thereby protecting the conductive surface of the member 301. As the material of the covering layer 305, it is possible to employ aluminum materials, for example.

Then, as shown in FIG. 5, the partially-protected member 301 is spray-coated with a hydrophilic slurry 307 through a mask 306. Although not shown in FIG. 5, when spray coating the slurry, the member 301 may be heated in advance to a temperature of 40-200° C. by a hotplate.

The hydrophilic slurry 307 may be prepared by dispersing a hydrophilic material into a dispersion medium. As the hydrophilic material, it is possible to employ silica for instance. As the dispersion medium, it is possible to employ a mixed solvent consisting of methanol and water, for example. With respect to the concentration of the hydrophilic material in the slurry and the quantity of spray, they may be suitably determined so as to obtain a desired hydrophilic layer. Preferably, the concentration of the hydrophilic material is within the range of 1-20% by weight.

As shown in FIG. 6, once the slurry that has been sprayed to the channel of the member is cured, a hydrophilic layer 304 formed of a laminated body constituted by the base layer 302 and the uneven layer 303 can be obtained. The thickness of the base layer 302 is preferably 0.2-3 μm. As long as the thickness of the base layer 302 is within this range, the liquid-discharging property can be further enhanced without raising any inconvenience. Depending on the quantity of coating, the thickness of the base layer 302 can be regulated to a predetermined range.

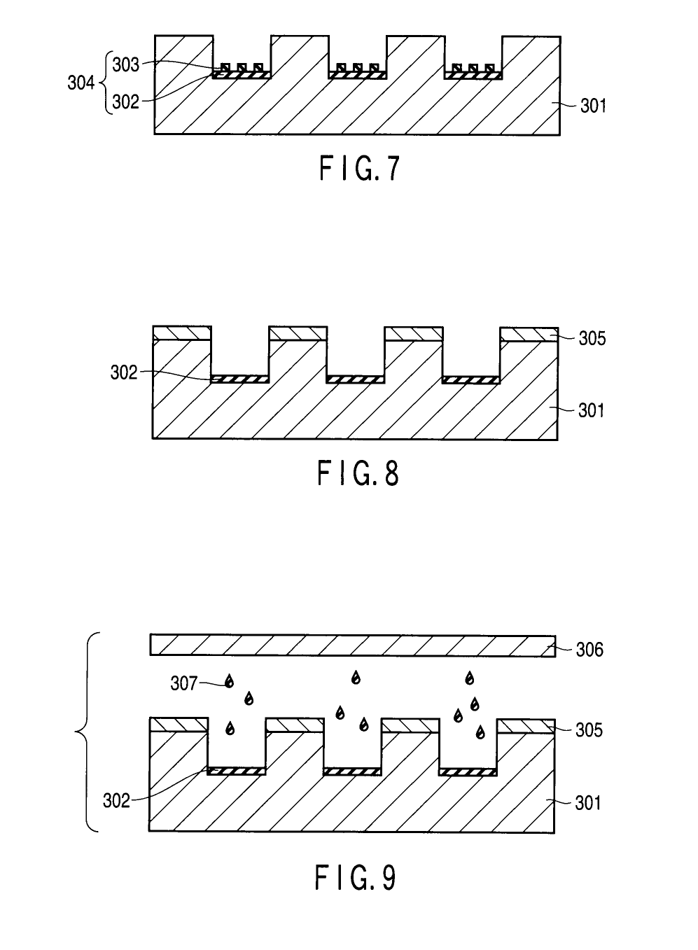

As the mask 306 is removed and then the covering layer 305 is removed from the conducting surface of member 301, a separator as shown in FIG. 7 can be obtained.

Under certain circumstances, the base layer 302 may be formed on the bottom of the channel of member 301 before positioning the mask 308 as shown in FIG. 8. Then, as shown in FIG. 9, the slurry 307 may be spray-coated through the mask 306. The process after this step may be carried out as already described above.

In the separator used in this embodiment, the surface configuration of the uneven layer 303 in the hydrophilic layer 304 is regulated as described below. Namely, the average interval Sm of the fine projections is 2×10² to 4×10² μm and the maximum height Ry of the projections is 5-15 μm.

If the average interval Sm of the fine projections of the surface of the uneven layer 303 is less than 2×10² μm or greater than 4×10² μm, the surface area of the bottom surface of separator cannot be sufficiently increased. As a result, the liquid-retaining property of the separator is deteriorated, resulting in the decrease of hydrophilicity of the separator. The average interval Sm of the fine projections can be regulated to a desired range by suitably controlling the dimension of meshes, for example.

Further, if the maximum height Ry of the projections is less than 5.0 μm, the surface area of the bottom surface of separator is decreased, resulting in the deterioration of hydrophilicity of the separator. On the other hand, if the Ry is increased higher than 15.0 μm, the moving resistance of liquid due to anchoring effects is increased, resulting in the deterioration of liquid-discharging property. Furthermore, the leakage of gas from the surface of gasket would be generated. The maximum height Ry of the projections can be regulated to a desired range by suitably controlling the quantity of coating, for example.

As described above, in this embodiment, the surface features of the hydrophilic layer disposed on the bottom of the channel of separator are regulated to predetermined ranges. More specifically, the projections having an average interval of 2×10² to 4×10² μm and the maximum height of 5-15 μm is formed on the surface of the hydrophilic layer. By doing so, it has been made possible to enhance the hydrophilicity of the separator. The features described above have been discovered for the first time by the present inventors.

The arithmetic average surface roughness Ra of the uneven surface of uneven layer 303 is preferably within the range of 0.5-1.5 μm. If the Ra is confined to this range, the liquid-discharging property of the separator can be further enhanced. As in the case of the aforementioned average interval Sm of the projections and the aforementioned maximum height Sy of the projections, the arithmetic average surface roughness Ra of the uneven layer are determined based on JIS B 0601-1994.

The aforementioned separator can be advantageously used in either of the cathode side or the anode side. When used as a cathode separator, the separator enhances the water-discharging property.

If a separator exhibiting poor wettablity for a fuel is used at the anode side, the channel of the anode causes various disadvantages. For example, at the time of startup, there may be a wall surface portion that is not wet, thereby causing air lock. Due to this, the channel may include a portion where the fuel does not flow. In the case where the fuel is eliminated from the channel of the anode at the time of stop, the wettability for the fuel must not be poor. If the wettabillity is poor, liquid drops may remain inside the channel. Unless the liquid drops are removed, the fuel remains in the channel. The remaining fuel may be changed in quality by the catalyst, and the resultant substance may degrade the reactivity of the catalyst.

When a separator exhibiting satisfactory wettability for the fuel is used, the aforementioned disadvantages in the channel of the anode can be avoided. The advantages in each operating condition are as follows: At the time of startup, the fuel spreads uniformly. This advantage is especially notable in the case of parallel channels and in the case of a type wherein the fuel is removed from the anode at the time of stop. In the operating condition, a sufficient amount of fuel is supplied to each channel. This advantage is especially notable in the case of parallel channels. The separator exhibiting improved wettability for a fuel does not easily form or keep liquid drops. At the time of stop, therefore, the fuel can be reliably removed from each portion of the channel of the anode.

As described above, the separator used in this embodiment comprises a metallic member having the channel; and a hydrophilic layer disposed on the bottom of the channel and constituted by a base layer and an uneven layer on the base layer. The surface of the uneven layer has fine projections, an average interval Sm of the projections is 2×10² to 4×10² μm and the maximum height Ry of the projections is 5-15 μm.

The base layer is preferably formed of a silica layer having a thickness ranging from 0.2 to 3 μm. The uneven layer preferably contains silica.

The separator can be manufactured by a method comprising:

protecting a conductive surface of a metallic member having a channel and the conductive surface; and

spray-coating a hydrophilic slurry containing 1-20 wt % of a hydrophilic material to a bottom of the channel through a mask while heating the metallic member at a temperature ranging from 40 to 200° C., thereby forming a hydrophilic layer comprising a base layer and an uneven layer on the base layer.

The aforementioned method may further comprise a process of spray-coating the slurry to the bottom of the channel without interposition of the mask before spray-coating the slurry to the bottom of the channel through the mask.

Next, another embodiment will be explained.

The separator used in another embodiment comprises a metallic member having a channel; and an oxide layer disposed on a bottom of the channel; wherein the oxide layer contains silica and 0.0001-30% by weight of tin oxide based on the weight of silica.

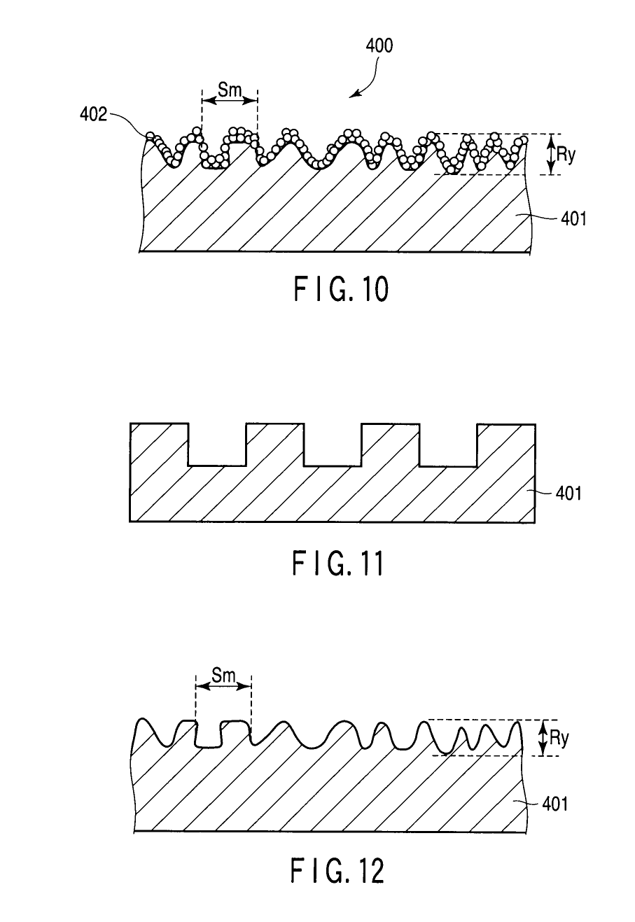

FIG. 10 shows an enlarged view of the bottom of the channel of this separator. In the separator 400 shown herein, an oxide layer 402 is formed on the bottom of the channel of the metallic member 401. This oxide layer 402 contains silica and tin oxide, wherein the content of the tin oxide is 0.0001-30% by weight based on the weight of silica.

The separator shown herein can be manufactured according to the following method for instance.

First of all, as shown in FIG. 11, a metallic member 401 is prepared. As the metal, it is possible to employ any metal as long as they have a predetermined electric conductivity and heat conductivity, so that there is not any particular restriction with regard to the material of the metal. For example, it is possible to employ a stainless steel plate or a material comprising stainless steel as a base material which is surface-treated for improving corrosion resistance and conductivity. As the method of surface treatment, it may include, for example, plating treatment, the vapor deposition of a metallic film such as gold and the cladding with a gold film. Further, it is also possible to employ a carbon-aluminum composite material comprising a base material made of aluminum and covered thereon with carbon.

Although the bottom of the channel in the member 401 may be flat, it may be formed to have an uneven surface including fine projections as shown in FIG. 12. The average interval Sm of the projections is preferably 1-20 μm and the maximum height Ry of the projections is preferably 1-5 μm. As long as the projections which are confined to these ranges are existed on the bottom of channel, it is possible to sufficiently secure the surface area of the separator. As a result, the hydrophilic property of the separator can be further enhanced. Herein, the values of these average interval Sm and maximum height Sy are determined based on JIS B 0601-1994.

The fine projections can be formed on the bottom of channel by a method such as a chemical treatment for instance.

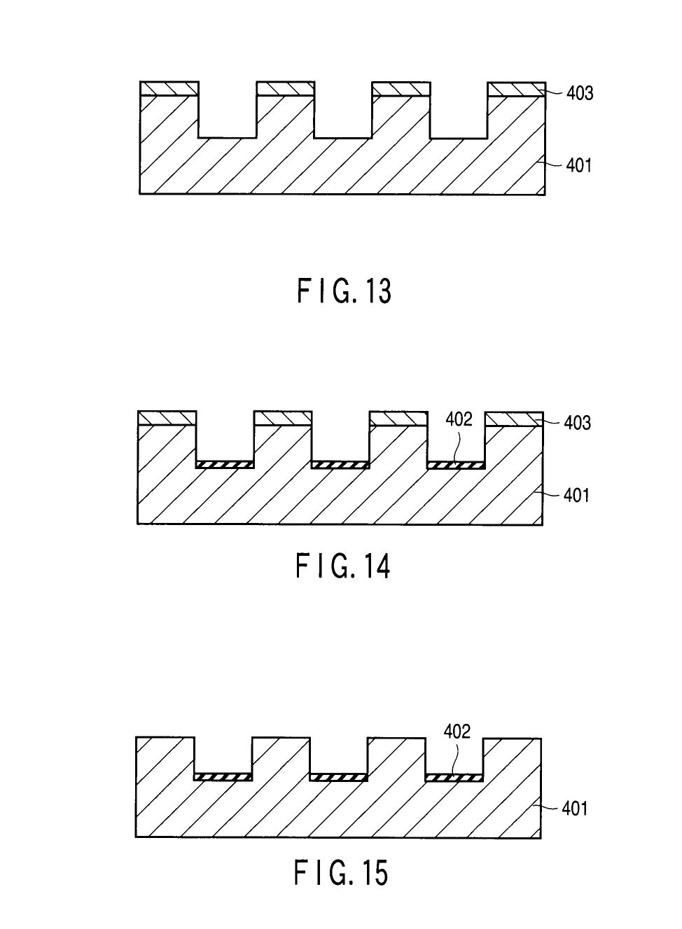

To the member 401 is attached a covering layer 403 as shown in FIG. 13, thereby protecting the conductive surface of the member 401. As the material of the covering layer 403, it is possible to employ aluminum materials, for example.

Then, as shown in FIG. 14, an oxide layer 402 is formed on the bottom of channel. The oxide layer 402 can be formed by spray-coating a predetermined hydrophilic slurry to the bottom of the channel while heating the member at a temperature ranging from 40 to 200° C. by a hotplate, for example.

The slurry may be prepared by dispersing a hydrophilic material into a dispersion medium. As the hydrophilic material, it is possible to employ a mixture consisting of silica and tin oxide. The content of the tin oxide is 0.0001-30% by weight based on the weight of silica. As the dispersion medium, it is possible to employ a mixed solvent consisting of methanol and water, for example. The concentration of the hydrophilic material in the slurry is preferably within the range of 1-20% by weight.

As shown in FIG. 14, once the slurry that has been sprayed to the channel of the member is cured, an oxide layer 402 can be obtained. The thickness of the oxide layer 402 is preferably 0.2-3 μm. As long as the thickness of the oxide layer 402 is confined to this range, the liquid-discharging property can be further enhanced without raising any inconvenience. Depending on the quantity of coating, the thickness of the oxide layer 402 can be regulated to a predetermined range.

After forming the oxide layer 402 on the bottom of the channel, the covering layer 403 is removed from the conducting surface of member 401, thereby obtaining a separator as shown in FIG. 15.

In the separator as described above, the oxide layer 402 having a predetermined composition is formed on the bottom of channel. This oxide layer 402 contains silica and tin oxide, wherein the content of the tin oxide is 0.0001-30% by weight based on the weight of silica.

If the content of the tin oxide is less than 0.0001% by weight based on the weight of silica, the drop of relative output is caused to increase, resulting in the decrease of relative output. On the other hand, if the content of the tin oxide is higher than 30% by weight based on the weight of silica, the affinity of the oxide layer 402 to liquid is decreased, thus deteriorating the hydrophilicity of the separator. These findings are discovered for the first time by the present inventors. The content of tin oxide is more preferably confined to 0.1-3% by weight based on the weight of silica.

As described above, due to the predetermined hydrophilic treatment performed to the bottom of channel, it is possible to obtain separators exhibiting excellent liquid absorbency and excellent water-discharging property.

The aforementioned separator can be advantageously used in either of the cathode side or the anode side. When used as a cathode separator, the separator enhances the water-discharging property.

If a separator exhibiting poor wettablity for a fuel is used at the anode side, the channel of the anode causes various disadvantages. For example, at the time of startup, there may be a wall surface portion that is not wet, thereby causing air lock. Due to this, the channel may include a portion where the fuel does not flow. In the case where the fuel is eliminated from the channel of the anode at the time of stop, the wettability for the fuel must not be poor. If the wettabillity is poor, liquid drops may remain inside the channel. Unless the liquid drops are removed, the fuel remains in the channel. The remaining fuel may be changed in quality by the catalyst, and the resultant substance may degrade the reactivity of the catalyst.

When a separator exhibiting satisfactory wettability for the fuel is used, the aforementioned disadvantages in the channel of the anode can be avoided. The advantages in each operating condition are as follows: At the time of startup, the fuel spreads uniformly. This advantage is especially notable in the case of parallel channels and in the case of a type wherein the fuel is removed from the anode at the time of stop. In the operating condition, a sufficient amount of fuel is supplied to each channel. This advantage is especially notable in the case of parallel channels. The separator exhibiting improved wettability for a fuel does not easily form or keep liquid drops. At the time of stop, therefore, the fuel can be reliably removed from each portion of the channel of the anode.

Next, embodiments will be illustrated.

### Embodiment I

Using a stainless steel member, the separator was manufactured according to the following method.

Silica as a hydrophilic material was dispersed in a dispersion medium or a mixed solvent comprising methanol and water, thereby obtaining a hydrophilic slurry containing 5 wt % of silica.

The member 301 was protected, on its conductive surface excluding the channel thereof, with the covering layer 305 and then placed on a hotplate to heat the member 301 to a temperature of 150° C.

A mask 306 was disposed above the member 301 having the protected conductive surface and then the member 301 was spray-coated with the slurry 307. As the mask 306, a stainless mesh was employed. The quantity of the slurry thus sprayed was adjusted by a spray gun. After finishing the spray of 40 mL of the slurry, the slurry was allowed to cure, thereby forming the hydrophilic layer 304 consisting of a laminate of the base layer 302 and the uneven layer 303 on the bottom of the channel of member 301.

Then, the mask 306 was removed and the covering layer 305 was removed from the conductive surface to obtain the separator 300. The separator obtained herein was designated as (I-1).

Further, the separators (I-2)-(I-9) were manufactured in the same manner as described above except that the conditions such as the quantity of coating and the kinds of mask mesh were altered. The separators thus obtained were examined with respects to the average interval Sm and the maximum height Ry of the projections in the uneven layer 303. These measurements were conducted based on JIS B 0601-1994. The results are summarized in the following Table 1 together with the conditions of forming the hydrophilic layer.

TABLE 1

| | Sm | Ry | | Hydrophilic |
|---|---|---|---|---|
| | (μm) | (μm) | Mask | treatment |
| I-1 | 336 | 14.4 | Yes | Yes |
| I-2 | 200 | 14.4 | Yes | Yes |
| I-3 | 400 | 14.4 | Yes | Yes |
| I-4 | 336 | 5 | Yes | Yes |
| I-5 | 336 | 15 | Yes | Yes |
| I-6 | 198 | 3.6 | No | No |
| I-7 | 156 | 18.4 | No | Yes |
| I-8 | 390 | 3 | Yes | Yes |
| I-9 | 500 | 6 | Yes | Yes |

In the separators (I-1)-(I-5) among nine separators shown in above Table 1, the average interval Sm of the projections was 2×10² to 4×10² μm and the maximum height Ry of the projections was 5-15 μm.

Further, the hydrophilic layer of each of these separators was examined with respect to the areal ratio of spreading thereof. The areal ratio of spreading was measured according to the following method. A water droplet of 0.1 μL was dropped from a position 1 cm above the separator and then the area of spreading of the water droplet after 30 seconds later was photographed, the photograph thus obtained being subsequently subjected to picture processing, thereby determining the areal ratio of spreading. In this case, the area of spreading in the separator (I-7) was assumed as being one and, based on this value, the relative value of the area of spreading in other separators was determined. The results obtained are summarized in the following Table 2.

TABLE 2

| | Areal ratio |
|---|---|
| | of spreading |
| I-1 | 1.3 |
| I-2 | 1.3 |
| I-3 | 1.3 |
| I-4 | 1.3 |
| I-5 | 1.3 |
| I-6 | — |
| I-7 | 1 |
| I-8 | 1 |
| I-9 | 1 |

As shown in above Table 2, the hydrophilic layers having, on their surfaces, projections wherein the average interval Sm thereof was confined to 2×10² to 4×10² μm and the maximum height Ry thereof was confined to 5-15 μm exhibited higher hydrophilicity as compared with the hydrophilic layers which failed to satisfy these conditions.

### (Method of Manufacturing the Fuel Cell)

A DMFC was manufactured using each of the separators obtained above as a cathode separator. First of all, Nafion 112 was prepared and cut out to obtain a sheet 40 mm long and 50 mm wide. Based on the specification “G. Q. Lu, et al., Electrochimica Acta 49 (2004), 821-828”, the Nafion (trademark) 112 was subjected to a pre-treatment using hydrogen peroxide and sulfuric acid to obtain an electrolytic film 10.

A PtRu alloy catalyst (PtRu Black HiSPEC 6000; available from Johnson & Matthey Co., Ltd.) and a perfluorocarbon sulfonate solution (Nafion [trademark] solution Aldrich SE-29992 Nafion [trademark]: 5 wt %; Dupont Co., Ltd.) were mixed and dispersed with each other to prepare an anode catalyst material. This material then coated on a PTFE sheet and dried to manufacture an anode catalyst layer. The quantity of the loading of the PtRu in the dried anode catalyst layer was approximately 6 mg/cm².

Further, a Pt/C catalyst (HP 40-wt % Pt on Vulcan XC-72R; E-Tek Co., Ltd.) and a perfluorocarbon sulfonate solution (Nafion solution Aldrich SE-20092, Nafion 5 wt %; Dupont Co., Ltd.) were mixed and dispersed with each other to prepare a cathode catalyst material. This material then coated on a PTFE sheet and dried to form a cathode catalyst layer. The quantity of the loading of the Pt in the dried cathode catalyst layer was approximately 2.6 mg/cm².

The anode catalyst layer and the cathode catalyst layer were respectively mounted on a PTFE sheet and, under this condition, cut into a piece 14 mm long and 100 mm wide. The anode catalyst layer 20 and the cathode catalyst layer 30 thus cut off were respectively placed to contact with and thermally press-bonded, taking approximately 3 minutes, to the electrolytic film 10 under the conditions of 125° C. and 10 kg/cm². Thereafter, the PTFE sheet was peeled off to obtain the catalyst-coated membrane (CCM) constituted by a laminated body comprising the electrolytic film 10 which was held between the anode catalyst layer 20a and the cathode catalyst layer 30a. The thickness of the anode catalyst layer 20a and of the cathode catalyst layer 30a was approximately 30 μm, respectively.

Then, a fuel control layer (not shown) was disposed on the anode catalyst layer 20a of the CCM and, a sheet of TGPH-120, 30 wt % waterproofed (available from E-Tek Co., Ltd.) which was formed of a carbon paper TGPH-090 (Toray Industries, Inc.) and was water-repellent-treated by PTFE (approximately 30 wt % in concentration) was laminated, as the anode GDL 20b, on the anode catalyst layer 20a of the CCM. On this anode GDL 20b, an anode separator 50 was disposed.

Then, an MPL-attached cathode GDL (Flat GDL LT-2500-W [approximately 360 μm thick]; available from E-Tek Co., Ltd.) was disposed on the cathode catalyst layer 30a of the CCM. The cathode separator 60 was disposed on the cathode GDL 30b.

### (Assessments)

Using a fuel supply means (not shown), a fuel was supplied to the anode GDL at a concentration of 1.2 M and at a fuel supply rate of 0.7 cc/min. Further, using an oxidizing gas supply means (not shown), air (oxidizing agent), 20.5% in oxygen concentration and 30% in relative humidity (RH %), was supplied from the cathode GDL to the fuel cell, thereby running the fuel cell for 500 hours and assessing the cell characteristics such as the output voltage thereof.

On this occasion, the temperature to be measured by temperature sensors (not shown) installed at the fuel supply means and at the oxidizing gas supply means was regulated to 60° C. by a temperature controller (not shown). The preliminary heating of air and fuel was not performed.

The voltage drop after 500 hours was summarized in the following Table 3.

TABLE 3

| | Voltage drop (%) |
|---|---|
| | after 500 hrs. |
| I-1 | 5 |
| I-2 | 10 |
| I-3 | 10 |
| I-4 | 10 |
| I-5 | 10 |
| I-6 | 50 |
| I-7 | 30 |
| I-8 | 40 |
| I-9 | 40 |

As seen from the results shown herein, in the case of the DMFC comprising a separator having a hydrophilic layer disposed on the bottom of the channel thereof wherein the hydrophilic layer was provided, on the surface thereof, with projections with the average interval Sm thereof being confined to 2×10² to 4×10² μm and the maximum height Ry thereof being confined to 5-15 μm, the voltage drop after 500 hours was not more than 10%. The voltage drop of this level would not give any substantial influence to the fuel cell. In these DMFCs, it was confirmed that the hydrophilicity of the separator was enhanced and the flooding resistance of fuel cell was greatly improved.

Whereas, in the case of the DMFC wherein a separator employed therein did not include the hydrophilic layer having the aforementioned predetermined surface features, the voltage drop after 500 hours was increased up to 50%.

### Embodiment II

Using a stainless steel member, the separator was manufactured according to the following method. The bottom of the channel of the member employed herein was flat.

Silica and tin oxide as hydrophilic materials were prepared. Tin oxide was mixed with silica at an amount of 0.0001% based on the weight of silica. The resultant mixture was dispersed in a dispersion medium or a mixed solvent comprising methanol and water, thereby obtaining a hydrophilic slurry. The concentration of the hydrophilic material in the slurry was 5.0005 wt %.

The member 401 was protected, on its conductive surface excluding the channel thereof, with the covering layer 403 and then placed on the hotplate to heat the member 401 to a temperature of 150° C.

The member 401 having the protected conductive surface was then spray-coated with the slurry. The quantity of the slurry thus sprayed was adjusted by controlling the quantity thereof to be ultimately coated. After finishing the spray of 40 mL of the slurry, the slurry was allowed to cure, thereby forming the oxide layer 402 containing silica and tin oxide on the bottom of the channel of member 401.

Then, the covering layer 403 was removed from the conductive surface to obtain a separator 400. The separator obtained herein was designated as (II-1).

Further, using the slurry where the concentration of tin oxide was altered as described below, the separators (II-2)-(II-7) were manufactured in the same manner as described above. In the cases of separators (II-6) and (II-7), a member employed therein was constructed to have, on the bottom of channel thereof, the projections wherein the average interval Sm thereof was confined to 300 μm and the maximum height Ry thereof was confined to 10 μm.

TABLE 4

| | Content (wt %) of tin |
|---|---|
| | oxide based on silica |
| II-1 | 0.0001 |
| II-2 | 30 |
| II-3 | 0.1 |
| II-4 | 3 |
| II-5 | 1 |
| II-6 | 1 |
| II-7 | 0 |

As shown in above Table 4, in the cases of the separators (II-1)-(II-6) among seven separators, tin oxide was contained in the oxide layer at an amount of 0.0001-30% based on the weight of the silica.

Further, the hydrophilic layer of each of these separators was examined with respect to the areal ratio of spreading thereof. The areal ratio of spreading was measured according to the following method. A water droplet of 0.1 μL was dropped from a position 1 cm above the separator and then the area of spreading of the water droplet after 30 seconds later was photographed, the photograph thus obtained being subsequently subjected to picture processing, thereby determining the areal ratio of spreading. In this case, the area of spreading in the separator (II-7) was assumed as being one and, based on this value, the relative value of the area of spreading in other separators was determined. The results obtained are summarized in the following Table 5.

TABLE 5

| | Areal ratio |
|---|---|
| | of spreading |
| II-1 | 1.3 |
| II-2 | 1.3 |
| II-3 | 1.3 |
| II-4 | 1.3 |
| II-5 | 1.3 |
| II-6 | 1.3 |
| II-7 | 1 |

As shown in above Table 5, the oxide layer containing tin oxide at an amount of 0.0001-30% based on the weight of the silica was found to exhibit higher hydrophilicity as compared with the oxide layer failing to meet the aforementioned conditions.

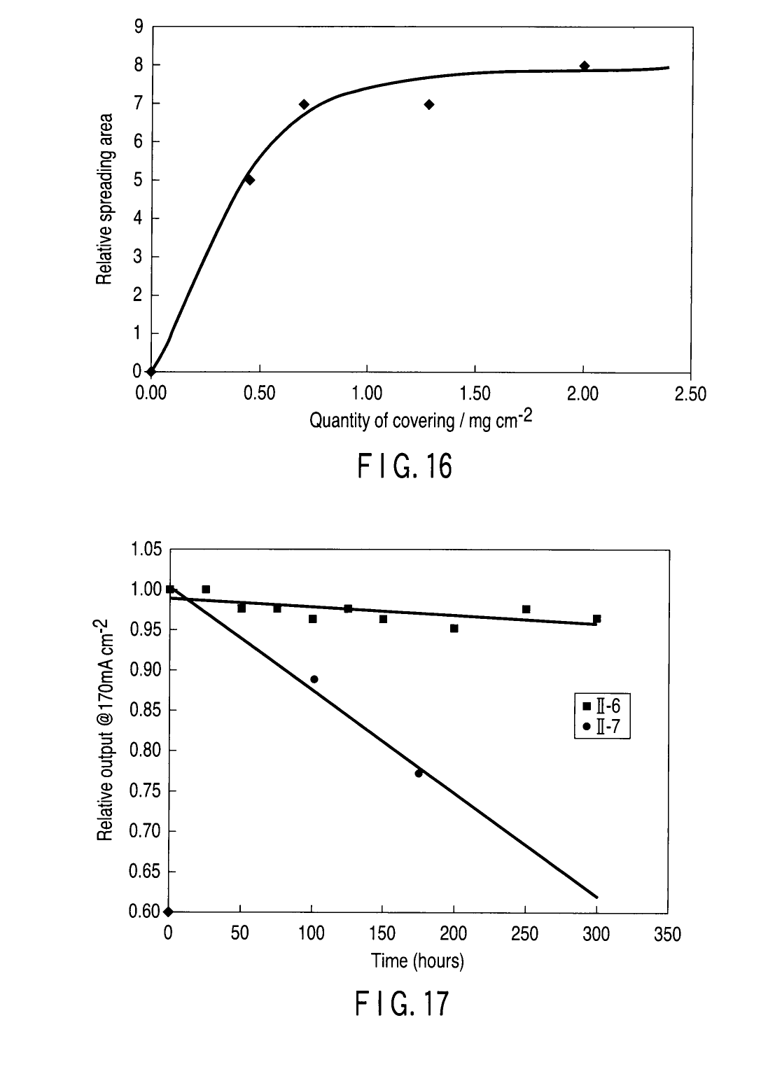

FIG. 16 shows in its graph the relationship between the quantity of covering and a relative area of spreading. As shown in the graph of FIG. 16, as the quantity of covering was increased, the relative area of spreading was correspondingly increased. However, as the quantity of covering was increased beyond 2.5 mg/cm², it was no longer possible to further increase the relative area of spreading and hence the relative area of spreading became constant.

A DMFC was manufactured using each of the separators obtained above as a cathode separator. Herein, the DMFC was manufactured in the same manner as described in “Method of Manufacturing the Fuel Cell” set forth in Embodiment I.

Using a fuel supply means (not shown), a fuel was supplied to the anode GDL at a concentration of 1.2 M and at a fuel supply rate of 0.7 cc/min. Further, using an oxidizing gas supply means (not shown), air (oxidizing agent), 20.5% in oxygen concentration and 30% in relative humidity (RH %), was supplied from the cathode GDL to the fuel cell, thereby running the fuel cell for 500 hours and assessing the cell characteristics such as the output voltage thereof.

On this occasion, the temperature to be measured by temperature sensors (not shown) installed at the fuel supply means and at the oxidizing gas supply means was regulated to 60° C. by a temperature controller (not shown). The preliminary heating of air and fuel was not performed.

The voltage drop after 500 hours was summarized in the following Table 6.

TABLE 6

| | Voltage drop (%) |
|---|---|
| | after 300 hrs. |
| II-1 | 10 |
| II-2 | 10 |
| II-3 | 9 |
| II-4 | 9 |
| II-5 | 7 |
| II-6 | 5 |
| II-7 | 40 |

As seen from the results shown herein, in the case of the DMFC comprising a separator having a hydrophilic layer disposed on the bottom of the channel thereof wherein the hydrophilic layer contained tin oxide at a ratio of 0.0001-30 wt % based on the weight of the silica, the voltage drop after 300 hours was not more than 10%. The voltage drop of this level would not give any substantial influence to the fuel cell. In these DMFCs, it was confirmed that the hydrophilicity of the separator was enhanced and the flooding resistance of the fuel cell was greatly improved.

Whereas, in the case of the DMFC wherein a separator employed therein did not include the hydrophilic layer containing the aforementioned predetermined quantity of tin oxide, the voltage drop after 300 hours was increased up to 40%.

FIG. 17 shows in its graph the changes with time of the relative output of above-described separators (II-6) and (II-7). When the hydrophilic layer was formed so as to contain tin oxide at a predetermined ratio, the lowering of the relative output of fuel cell was retained at approximately 5% at most even after the elapse of 300 hours. Further, even after the elapse of 1000 hours, the lowering of the relative output of fuel cell was retained at approximately 5% at most. By contrast, it will be recognized that when the hydrophilic layer was formed so as not to contain tin oxide, the output of fuel cell was already lowered down to an unallowable level even after the elapse of 40 hours.

The present invention is not limited to the above-described embodiments per se but constituent elements of these embodiments may be variously modified in actual use thereof without departing from the spirit of the present invention. Further, the constituent elements described in these various embodiments may be suitably combined to create various inventions. For example, some of the constituent elements described in these embodiments may be deleted. Further, the constituent elements described in different embodiments may be optionally combined with each other.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fuel cell comprising:
a membrane electrode assembly comprising an electrolytic film sandwiched between an anode catalyst layer and a cathode catalyst layer, an anode gas diffusion layer disposed adjacent to the anode catalyst layer and a cathode gas diffusion layer disposed adjacent to the cathode catalyst layer; and
a pair of separators which are in contact with the anode gas diffusion layer and the cathode gas diffusion layer, respectively,
at least one of the separators comprising:
a metallic member having a channel; and
an oxide layer disposed on a bottom of the channel and comprising silica and tin oxide which accounts for 0.0001-30% by weight of silica.

2. The fuel cell according to claim 1, wherein the tin oxide accounts for 0.1-3% by weight of silica.

3. The fuel cell according to claim 1, wherein the bottom of the channel in the metallic member has an uneven surface comprising projections.

4. The fuel cell according to claim 3, wherein an average interval of the projections is 1-20 μm.

5. The fuel cell according to claim 3, wherein a maximum height of the projections is 1-5 μm.

6. The fuel cell according to claim 1, wherein the oxide layer has a thickness ranging from 0.2 to 3 μm.

7. The fuel cell according to claim 1, wherein the metallic member is made of a stainless steel plate or a material comprising stainless steel which is surface-treated.

8. The fuel cell according to claim 7, wherein a surface of the stainless steel is treated with plating, vapor deposition of a metallic layer, or cladding with a gold layer.

9. The fuel cell according to claim 1, wherein the metallic member is made of a carbon-aluminum composite material.

10. The fuel cell according to claim 1, wherein the anode catalyst layer comprises a PtRu alloy catalyst.

11. The fuel cell according to claim 10, wherein a content of the PtRu alloy catalyst in the anode catalyst layer is 1-30 mg/cm².

12. The fuel cell according to claim 10, wherein the anode catalyst layer is formed of an anode catalyst material comprising the PtRu alloy catalyst and perfluorocarbon sulfonate.

13. The fuel cell according to claim 1, wherein the cathode catalyst layer comprises a Pt-supported carbon catalyst.

14. The fuel cell according to claim 13, wherein a content of the Pt-supported carbon catalyst in the cathode catalyst layer is 0.5-15 mg/cm².

15. The fuel cell according to claim 13, wherein the cathode catalyst layer is formed of a cathode catalyst material comprising the Pt-supported carbon catalyst and perfluorocarbon sulfonate.

16. The fuel cell according to claim 1, wherein the electrolytic film comprises a perfluorocarbon sulfonate film.
